(19) United States
(12) Patent Application Publication
(10) Pub. No.: US 2014/0178107 A1
(43) Pub. Date: Jun. 26, 2014

(54) IMAGE FORMING DEVICE AND METHOD OF MANUFACTURING SAME

(71) Applicant: Toru Masuyama, Yokohama-shi (JP)

(72) Inventor: Toru Masuyama, Yokohama-shi (JP)

(73) Assignee: BRIDGESTONE CORPORATION, Chuo-ku, Tokyo (JP)

(21) Appl. No.: 14/232,353

(22) PCT Filed: Aug. 8, 2012
(86) PCT No.: PCT/JP2012/070254

§ 371 Date: Jan. 13, 2014

(30) Foreign Application Priority Data
Aug. 8, 2011 (JP) 2011-173328

(51) Int. Cl. G03G 15/08; G03G 15/16; G03G 21/00

(52) U.S. Cl. CPC G03G 15/2003
USPC 399/281; 29/428; 399/313; 399/357

(57) ABSTRACT

Provided is an image forming device in which the cost needed for a roller member as a whole can be reduced, as well as a manufacturing process of the roller member can be simplified, and a method of manufacturing the roller member.

Provided is an image forming device comprising, on the outer periphery of a shaft, at least two types of rollers each having an elastic layer composed of polyurethane foam of the same composition, in which the at least two types of rollers are selected from the group consisting of a toner feed roller, a transfer roller and a cleaning roller. At least one of the at least two types of rollers is preferably subjected to a heat pressing process.

### TECHNICAL FIELD

The present invention relates to an image forming device and a method of manufacturing the same, and more specifically, to an image forming device comprising at least two types of rollers among a toner feed roller, a transfer roller, and a cleaning roller, and a method of manufacturing the same.

### BACKGROUND ART

In general, in a developing unit of an electrophotography image forming device such as a copier or a printer, as shown in FIG. 1, an image forming member 10 such as a photoreceptor retaining an electrostatic latent image, a developing roller 11 which makes the electrostatic latent image a visible image by making the image forming body 10 come in contact with the roller and attaching toner 20 which is supported on the surface of the roller to the image forming member 10, and a toner-feed roller 12 for providing the developing roller 11 with toner 20 are provided. In the illustrated developing unit, an image formation is performed by a series of processes in which a toner 20 is conveyed from a toner storage unit 13, via a toner-feed roller 12 and a developing roller 11, to an image forming member 10. In this figure, the reference numeral 14 indicates a transfer roller for transferring a toner adhered on a latent image on the image forming member 10 to a recording medium, by which, after the transferring, the toner which is remained on the image forming member 10 is removed by a cleaning roller 15. The reference numeral 16 indicates an layer forming blade, and the reference numeral 17 indicates a charging roller.

In general, such a roller member which is used in an image forming device has a structure in which an elastic layer composed of a rubber, a high molecular-weight elastomer, a high molecular-weight foam, or the like is supported on the outer periphery of a shaft made of a metal material or the like. Regarding the elastic layer, usually, the combination of materials is determined depending on the needed properties for the function of each roller member, and the physical properties thereof are adjusted.

For example, Patent Document 1 discloses a method of manufacturing a roller having an elastic layer composed of a foam, the method comprising: in order mainly to secure needed characteristics of a developer feed roller, pressing the roller into a cylindrical member; heating the outer periphery of the cylindrical member; and taking out the roller from the cylindrical member. Patent Document 2 discloses a cleaning roller which is composed of a foam and is formed such that the roller is compressed in the radial direction of the roller. Patent Document 3 discloses a method of manufacturing a roller cleaner, the method comprising: cutting a melamine foam block into a predetermined prism shape; making a through hole on a center portion in the cross-section of the prism shaped material in the longitudinal direction by precise hole machining; inserting a core which is prepared in advance into the through hole of the prism shaped material and heat-bonding them to obtain a raw material A; precisely preliminary grinding the outer periphery of the melamine foam prism shaped material of the raw material A to obtain a raw material B; pressing the raw material B into a predetermined cylindrical mold; heating at a predetermined temperature for a predetermined time; and, further, after cooling, precisely finish-grinding the outer periphery of a raw material C which is pulled out from the cylindrical mold, thereby obtaining a roller cleaner product.

### RELATED ART DOCUMENTS

### Patent Documents

Patent Document 1: Japanese Unexamined Patent Application Publication No. H09-297512 (claims and the like)
Patent Document 2: Japanese Unexamined Patent Application Publication No. 2005-195709 (claims and the like)
Patent Document 3: Japanese Unexamined Patent Application Publication No. 2005-241906 (claims and the like)

### SUMMARY OF THE INVENTION

### Problems to be Solved by the Invention

Since, as mentioned above, various roller members used for an image forming device each have different needed properties, conventionally, an elastic layer composed of a different combination of materials is formed on the outer periphery of a shaft, and the various roller members have been used for individual purposes. It has therefore been necessary to prepare different raw materials for each type of the rollers and it has been taken cost and time.

Accordingly, an object of the present invention is to resolve the above-mentioned problems and to provide an image forming device in which the cost needed for a roller member as a whole can be reduced, as well as the production efficiency can be improved by simplifying the manufacturing process of the roller member, and a method of manufacturing the roller member.

### Means for Solving the Problems

The present inventors intensively studied to find that the above-mentioned problems can be resolved by employing the constitution below, thereby solving the problems of the present invention.

Specifically, an image forming device of the present invention comprises, on the outer periphery of a shaft, at least two types of rollers each having an elastic layer composed of polyurethane foam of the same composition, wherein the at least two types of rollers are selected from the group consisting of a toner feed roller, a transfer roller and a cleaning roller. In the image forming device of the present invention, at least one of the at least two types of rollers is preferably subjected to a heat pressing process.

More specifically, the image forming device may be one in which the at least two types of rollers are a toner feed roller and a transfer roller, the compression rate of the toner feed roller in the heat pressing process is lower than 30%, in particular, 20% or lower, and the compression rate of the transfer roller in the heat pressing process is from 5% to 50%, in particular, from 10% to 30%. The image forming device may also be one in which the at least two types of rollers are a toner feed roller and a cleaning roller, the compression rate of the toner feed roller in the heat pressing process is lower than 30%, in particular, 20% or lower, and the compression rate of the cleaning roller in the heat pressing process is from 5% to 50%, in particular, from 20% to 30%. Further, the image forming device may also be one in which the at least two types of rollers are a transfer roller and a cleaning roller, the compression rate of the transfer roller in the heat pressing process is from 5% to 50%, in particular, from 10% to 30%, and the compression rate of the cleaning roller in the heat pressing process is from 5% to 50%, in particular, from 20% to 30%.

Still further, the image forming device may also be one in which the at least two types of rollers are a toner feed roller, a transfer roller and a cleaning roller, the compression rate of the toner feed roller in the heat pressing process is lower than 30%, in particular, 20% or lower, the compression rate of the transfer roller in the heat pressing process is from 5% to 50%, in particular, from 10% to 30%, and the compression rate of the cleaning roller in the heat pressing process is from 5% to 50%, in particular, from 20% to 30%.

The method of manufacturing an image forming device of the present invention is a method of manufacturing an image forming device comprising at least two types of rollers selected from the group consisting of a toner feed roller, a transfer roller and a cleaning roller, characterized in that, as the at least two types of rollers, one comprising, on the outer periphery of a shaft, an elastic layer composed of polyurethane foam of the same composition is used. In the method of manufacturing of the present invention, at least one of the at least two types of rollers is preferably subjected to a heat pressing process.

### Effects of the Invention

According to the present invention, by employing the above-mentioned constitution, it becomes possible to attain an image forming device in which the cost needed for a roller member as a whole can be reduced, as well as the production efficiency can be improved by simplifying the manufacturing process of the roller member, and a method of manufacturing the roller member.

### BRIEF DESCRIPTION OF THE DRAWINGS

FIG. 1 is a schematic view illustrating a developing unit of one example of an image forming device of the present invention.

### MODE FOR CARRYING OUT THE INVENTION

An embodiment of the present invention will now be described in detail with reference to the Drawing.

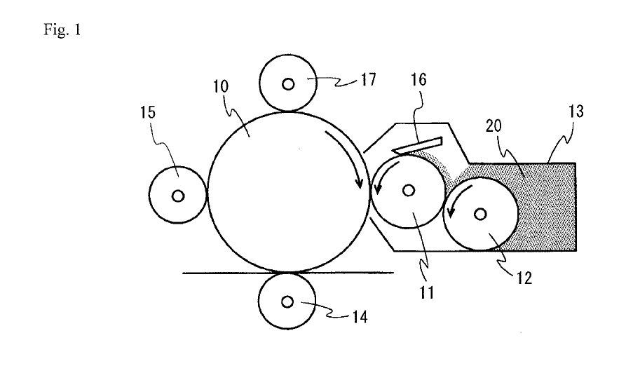

FIG. 1 is a schematic view illustrating a developing unit of one example of an image forming device of the present invention. The image forming device of the present invention is characterized by comprising, on the outer periphery of a shaft, as rollers each having an elastic layer composed of polyurethane foam of the same composition, at least two types of rollers selected from the group consisting of a toner feed roller, a transfer roller and a cleaning roller.

By this, since the same combination of materials can be applied to the at least two types of rollers used for an image forming device, the manufacturing cost needed for a roller member as a whole can be reduced, as well as the production efficiency can be improved by simplifying the manufacturing process of the roller member

In the present invention, any combination of at least two types of rollers each comprising an elastic layer composed of polyurethane foam of the same composition may be employed as long as these roller are selected from a toner feed roller, a transfer roller and a cleaning roller. Specific examples thereof include: a combination of two types of rollers, a toner feed roller and a transfer roller; a combination of two types of rollers, a toner feed roller and a cleaning roller; a combination of two types of rollers, a transfer roller and a cleaning roller; and a combination of three types of rollers, a toner feed roller, a transfer roller and a cleaning roller.

In the present invention, the low hardness, low electrical resistance, and low cost, which are common required performance for the rollers, can be attained by using an electrically conductive polyurethane foam which has a low density and which is inexpensive. The detailed composition of the foam is described below. In the present invention, in order to further satisfy different required performances for each roller, the roller is preferably subjected to a heat pressing process. The term “heat pressing process” specifically refers to a process in which a roller after molding is inserted into a cylindrical member (pipe) having a predetermined inner diameter corresponding to a predetermined compression rate and is heated in an oven in a state in which both sides of the shaft are fixed with caps at a predetermined temperature for a predetermined time. By adjusting the compression rate in the heat pressing process, the surface characteristics of a roller are appropriately adjusted while maintaining low cost, thereby satisfying required performances for each type of roller and surely attaining desired required performances of the device as a whole. Here, the compression rate (%) of the roller is defined by the following expression:

{(R−r)/R}×100 (%),

where the thickness of the elastic layer of the roller before the insertion into the cylindrical member is R (mm), and the thickness of the compressed elastic layer of the roller after the insertion into the cylindrical member is r (mm).

The above-mentioned heat pressing process is preferably carried out for at least one among the at least two rollers each using polyurethane foam of the same composition. Specifically, the heat pressing process is carried out for each roller in accordance with the conditions below.

The toner feed roller is needed to have a low hardness in order to prevent deterioration of toner, and is also needed to have a low electrical resistance in order to stably charging the toner. In order to form a toner layer uniformly on a developing roller, the sweeping ability of residual toner on the developing roller is important. At the same time, the developing roller also needs to have a high opening rate on the surface in order to convey toner stably. Such a toner feed roller can satisfy the above mentioned required performance without carrying out a heat pressing process. When a heat pressing process is carried out, the compression rate is suitably lower than 30%, more suitably 20% or lower, and further suitably 10% or lower. If the compression rate is too high, the toner conveying ability deteriorates.

The transfer roller needs to have a low hardness in order to prevent, in a color printer, a so-called retransfer in which toner is reverse transferred from an intermediate transfer member to a photoreceptor in subsequent color units, and also needs to have a low electrical resistance, in other words, to be used with a low voltage in order to prevent toner scattering. Since when there is a fuzz on the surface of a roller, pressure on the fuzz portion is strong and a transfer failure (white patch) is generated at a portion where there is no fuzz, it is important that there be little fuzz and that the surface of the roller be smooth. When a heat pressing process is carried out on such a transfer roller, the compression rate is suitably from 5% to 50%, more suitably from 10% to 30%. When the compression rate is too low, a desired surface smoothness may not be obtained. When the compression rate is too high, a load at the time of inserting a roller into a cylindrical member becomes high, which deteriorates workability. When the compression rate becomes excessively high, the foam may be broken at the time of insertion.

The cleaning roller needs to have a low hardness in order to prevent scratch on a photoreceptor, a charging roller, an intermediate transfer feed, and needs to have a low electrical resistance in order to electrically attract and collect toner. In addition, in order to secure a high sweeping ability for residual toner, paper powder, a binder for paper, or the like on a photoreceptor, a charging roller, or an intermediate transfer member, it is important that cells on the surface be densely distributed and that the opening rate of the surface be reduced. When a heat pressing process is carried out on such a cleaning roller, the compression rate is suitably from 5% to 50%, more suitably from 20% to 30%. When the compression rate is too low, a desired sweeping ability may not be obtained. When the compression rate is too high, a load at the time of inserting a roller into a cylindrical member becomes high, which deteriorates workability. When the compression rate becomes excessively high, the foam may be broken at the time of insertion.

In the present invention, the heat pressing process can be carried out at a temperature of from 150 to 200° C. for about 10 to 60 minutes. When the temperature of the heat pressing process is too low or too high, a desired required performance may not be obtained. When the time for heat pressing process is too short or too long, a desired required performance may not be obtained.

Suitably, the image forming device of the present invention comprises the above-mentioned at least two rollers having an elastic layer composed of polyurethane foam of the same composition, thereby obtaining an intended effect of the present invention. In the present invention, the specific composition of the above-mentioned polyurethane foam or a specific constitution of the image forming device except that the image forming device comprises the above-mentioned at least two rollers is not particularly limited, and can be appropriately determined according to a normal method.

In the present invention, a shaft which constitutes a roller is not particularly limited, and examples thereof include: one obtained by coating a steel material such as a sulfur free-cutting steel with zinc or the like; a cored bar constituted by a solid body made of a metal such as iron, stainless steel or aluminum; and a metal shaft such as a metal cylindrical body whose inside is hollowed. In the present invention, the shaft may vary depending on the type of roller.

In the present invention, as polyurethane foam which constitutes a roller, for example, one which is manufactured by stirring and mixing a compound having two or more active hydrogen atoms and a compound having two or more isocyanate groups together with additives such as a catalyst, a foaming agent, and a foam stabilizer to cause to foam and to be cured can be used.

Specifically, in the present invention, for example, an electrically conductive polyurethane foam obtained by adding, to urethane prepolymer, an aqueous electrically conductive carbon particle dispersion in an amount in which an excess amount of water in chemical equivalent with respect to the isocyanate group of the urethane prepolymer is provided and by mixing and foaming can be used. In this case, a prepolymer obtained by reacting a polyoxyethylene-polyoxypropylene copolymerized polyether polyol whose polyoxyethylene chain content is 30% by mass or smaller based on the total amount of polyol with an excess isocyanate component in chemical equivalent is used as the urethane prepolymer, and foaming after mixing is carried out in a mold having an internal volume smaller than the volume of the foam in the case of free foaming under an atmospheric pressure.

Polyol to be used for the preparation of the above-mentioned urethane prepolymer, is manufactured by adding ethylene oxide or propylene oxide to one or more types of compounds containing two or more active hydrogen atoms such as polyhydric alcohols, for example, glycerin, trimethylolpropane, pentaerythritol, and sorbitol, or amines. A polyol in which the molecular weight of a polyoxyethylene chain formed by the addition of ethylene oxide is 30% by mass or less based on the molecular weight of the total amount of polyol which is finally obtained is used singly. Alternatively, a polyol which is adjusted such that the amount of polyoxyethylene chain based on the total amount of polyol manufactured by blending a polyol having a polyoxyethylene chain and a polyol not having a polyoxyethylene chain is 30% by mass or smaller is used.

The above-mentioned urethane prepolymer is prepared by reacting an isocyanate component in an amount higher than the chemical equivalent with the above-mentioned polyol to contain an excess amount of the isocyanate component, and preferably the NCO group content in the urethane prepolymer is from 3 to 30% by mass. When the NCO group content of the urethane prepolymer is less than 3% by mass, the viscosity of the system is increased and the urethane prepolymer becomes difficult to handle. Since the amount of gas which is generated becomes small, the control of the density of the foam also becomes difficult. On the other hand, when the NCO group content is higher than 30% by mass, the amount of gas generated is too large and a closely packed cells are hard to obtain, which is not practical.

Examples of isocyanate which is used for the preparation of the above-mentioned urethane prepolymer include tolylene diisocyanate (TDI), diphenylmethane diisocyanate (MDI), hexamethylene diisocyanate, naphthalene diisocyanate, cyclohexyl-methane diisocyanate, xylylene diisocyanate, polymethyl polyphenyl isocyanate, crude TDI, crude MDI, and modified MDI.

The aqueous dispersion containing the above-mentioned electrically conductive carbon particle is obtained by dispersing an electrically conductive carbon particle such as carbon black or graphite in water together with a surface-active agent or the like. From the viewpoint of the dispersibility or the viscosity of the aqueous dispersion or the like, the content of carbon particle is preferably from 5 to 50% by mass. Any type of carbon black such as furnace black, thermal black, channel black, acetylene black, or color black can be used.

In the manufacture of the above-mentioned electrically conductive polyurethane foam, other than the aqueous dispersion of a urethane prepolymer and an electrically conductive carbon particle, a silicone foam stabilizer, an amine, or a tin catalyst, as well as, as needed, a low-boiling-point solvent can be used as an auxiliary foaming agent as a third component. Regarding the type and the like of the auxiliary foaming agent, those of one for manufacturing a common polyurethane foam are employed and not particularly limited thereto.

Regarding the mixing ratio of the urethane prepolymer and the aqueous dispersion of the electrically conductive carbon particle, the aqueous dispersion of the electrically conductive carbon in an amount in which water is excess in chemical equivalent with respect to the isocyanate group of urethane prepolymer is added. When the ratio of the above-mentioned aqueous dispersion low, it is difficult to add an electrically conductive carbon in an amount in which a sufficient electrical conductivity is imparted to a polyurethane foam which is finally obtained, and the expansion ratio is increased, thereby not obtaining closely packed cells. Although the upper limit of the amount of water is not particularly limited, when the amount of water is not less than 300 times in chemical equivalent with respect to the isocyanate group in the urethane prepolymer, uniform mixing becomes difficult in view of the compatibility with the urethane prepolymer, which is not preferable.

As the mold used in the above-mentioned manufacturing method, a hermetically sealed mold is preferred, and the internal volume of the mold is smaller, at least, than the volume of a foam which is obtained by free foaming under an atmospheric pressure. Assumably, since, when such a mold is used, the pressure in the mold at the time of molding is necessarily higher than atmospheric pressure, a cell becomes stabilized due to pressurized molding in a mold while cell roughening, crack or the like occurs when free foaming is performed under an atmospheric pressure.

The ratio of the internal volume of the mold to the volume of free foaming under atmospheric atmosphere is, at least, smaller than 1, and preferably in a range of 0.5 to 0.9. When the ratio is less than 0.5, the pressure which is applied to the mold during foaming becomes high. As the result, the design of the mold becomes difficult, it takes time to release the pressure of the mold since the cell of the product becomes a closed cell, or the like, which deteriorates the productivity. On the other hand, when the ratio is 0.9 or higher, the cell tends to be rough.

As a foam according to the present invention, other than an electrically conductive polyurethane foam obtained by molding in the above-mentioned mold, a urethane foam manufactured by a method disclosed in Japanese Patent 3480028, specifically, manufactured by mixing a polyether polyol including a mixture of homogeneous diols including two kinds of homogeneous diols which have an average molecular weight difference therebetween of 800 to 3600 at 50% by mass in total with respect to polyol ingredient, isocyanate, water, catalyst and foaming agent, being foamed and being left to stand can also be used. As used herein, the term “homogeneous diol” generally means one diol, or means two or more kinds of diols having an average molecular weight difference therebetween of 400 or less. The term “average molecular weight difference” means a difference between the respective average molecular weights of object diols. If there is a lot of combinations of the difference, an “average molecular weight difference” particularly means the largest difference.

Examples of a polyether polyol used for manufacturing the above-mentioned urethane foam include (1) a polyether polyol of such a type that, for example, propylene oxide alone is added to diethylene glycol, (2) a polyether polyol of such a type that, for example, propylene oxide and ethylene oxide are added in block or randomly to diethylene glycol, and (3) a polyether polyol of such a type that, for example, acrylonitrile or styrene is grafted to the above (1) or (2), and in order to achieve more effect, the polyether polyol of type (1) is preferred.

Examples of an initiator used for manufacturing the above-mentioned polyether polyol include polyhydric alcohol, polyhydric phenol, mono- or poly-amine. Polyhydric alcohol and polyhydric phenol are preferred. Polyhydric alcohol is particularly preferred. Examples of polyhydric alcohol include ethylene glycol, diethylene glycol, triethylene glycol, propylene glycol, 1,3-butanediol, and 1,4-butanediol. Among these, diethylene glycol is more preferred.

Examples of the polyether polyol component may include a polyol component other than diol. Examples of such a polyol component include a trifunctional polyol usually used for manufacturing a urethane foam such as a polyol in which alkylene oxide such as propylene oxide is added to a glycerin base, or a polyol made by adding two kinds of alkylene oxides such as propylene oxide and ethylene oxide randomly or in block. Examples of a polyfunctional polyol include a polyether polyol or the like in which the same substances as above are added to saccharose base.

As the above-mentioned isocyanate component, tolylene diisocyanate, 4,4-diphenylmethane diisocyanate, polymethylene polyphenyl isocyanate or the like can be used singly or used in combination. Among these, tolylene diisocyanate is particularly preferable.

As the above-mentioned catalyst and foaming agent, the type and the amount thereof used are not particularly limited and a known catalyst and foaming agent can be used. Examples of the catalyst include an amine catalyst such as triethylenediamine, tetramethylenehexadiamine, or dimethylcyclohexylamine and an organic tin catalyst such as stannous octoate, or dibutyltin dilaurate. Examples of the foaming agent include methylene chloride, CFC-123, CFC-141b.

Further, to the above-mentioned polyurethane foam obtained by free foaming, other than the above-mentioned additives, a variety of additives such as a flame retardant, an antioxidant, an ultraviolet absorbing agent, and a foam stabilizer can be appropriately added. Specific examples of the foam stabilizer include a variety of siloxanes, and polyalkylene oxide block copolymers.

Here, examples of a method of imparting an electrical conductivity to the above-mentioned polyurethane foam obtained by free foaming include a method in which a conducting agent is added to the raw materials of the above-mentioned polyurethane foam in advance, and a method in which a conducting agent is impregnated in a manufactured polyurethane foam. The latter method is preferred from the viewpoint of high flexibility of the design. Specifically, a method in which a polyurethane foam is impregnated with an impregnation liquid containing a conducting agent and a binder to impart an electrical conductivity can be used. By appropriately determining the amount of the conducting agent and the amount of the impregnation liquid in the impregnation liquid, the electrical resistivity of the polyurethane foam can be determined to a predetermined value, and the electrical resistivity of the toner feed roller can be adjusted in the above-mentioned predetermined range.

For the above-mentioned conducting agent, carbonaceous particle such as carbon black or graphite, metal powder such as silver or nickel, electrically conductive metal oxide such as tin dioxide, titanium dioxide, zinc oxide can be used singly. Alternatively, those obtained by covering an insulation particle such as barium sulfate as a core body with the above-mentioned electrically conductive metal oxide in a wet manner, electrically conductive metal carbide, electrically conductive metal nitride, electrically conductive metal boride can be used singly or in combination of a plurality of kinds thereof. From the viewpoint of the cost, carbon black is preferable, and from the viewpoint of controllability, electrically conductive metal oxide is preferable. For such a conducting agent, a fine particle having an average particle size of 100 nm or smaller, in particular, 50 nm or smaller is preferably used.

As a binder used for an impregnation liquid, acrylic resins such as acrylate resins, polyacrylate resins, acrylate-styrene copolymer resins, acrylate-vinyl acetate copolymer resins; polyvinyl alcohols, polyacrylamides, polyvinyl chloride resins, urethane resins, vinyl acetate resins, butadiene resins, epoxy resins, alkyd resins, melamine resins, and chloroprene rubbers or the like may be exemplified. Particularly preferred are acrylate resins, urethane resins and chloroprene rubbers. These binders may be used singly, or in combination as a mixture of two or more thereof. Although a conducting agent cannot bind rigidly to the cell wall of urethane foam if it is impregnated singly, a conducting agent binds rigidly to the cell wall of urethane foam by adding the binder to form a stable conducting agent layer in cells of the urethane foam.

The compounding ratio of the above-mentioned conducting agent and binder is preferably 10 to 110 parts by mass, particularly 30 to 50 parts by mass of solid content of the conducting agent with respect to 100 parts by mass of solid content of the binder. If the conducting agent is larger than the above range, adhesion to substrate urethane foam tends to be insufficient. On the other hand, if the conducting agent is smaller than the above range, the surface resistance of the toner feed roller tends to be unstable.

To the above-mentioned impregnation liquid, in addition to a conducting agent and binder, a proper amount of water and an organic solvent such as toluene or ethyl acetate can be added. Such a solvent is preferably added such that the viscosity of the impregnation liquid is about 5 to 300 cps (25° C.). Setting the viscosity in this range makes an adhesion operation by impregnation more readily. Further, to the impregnating solution, other additives than those mentioned above, such as a mineral oil based antifoaming agent, a silicone based antifoaming agent, a surface-active agent, a charge controlling agent can be added as required. Such an additive is preferably added in an amount of about 0.001 to 10 parts by mass, particularly in an amount of 0.001 to 0.1 parts by mass with respect to 100 parts by mass of the impregnation liquid.

In a method in which electrical conductivity is imparted to a polyurethane foam by using the above-mentioned impregnation liquid, for example, powdery conducting agent and binder are dispersed and contained in water or an organic solvent, as needed, together with other additives to prepare an impregnation liquid; a block-shaped polyurethane foam is immersed in the impregnation liquid; and an air bubble in the polyurethane foam is impregnated with the impregnation liquid. Thereafter, the polyurethane foam is taken out from the impregnation liquid, compressed to remove a residual impregnation liquid, followed by heat drying to remove water or the like, thereby fixing the conducting agent together with the binder in the air bubble of the polyurethane foam.

The electrically conductive polyurethane foam obtained by a manufacturing method using a mold among the above-mentioned methods is characterized in that the size of the cell is relatively small; that the foam contains a portion where cells are communicated with each other and a portion of separate cells; and that there are relatively large portion of separate cells. The density of such an electrically conductive polyurethane foam is suitably from 0.03 to 0.13 g/cm³, and the average cell diameter is suitably in a range of 210 to 270 μm.

The electrically conductive polyurethane foam obtained by a manufacturing method using free foaming among the above-mentioned methods has a relatively large cell diameter and is basically composed of cells which are communicated with each other. The density of such an electrically conductive polyurethane foam is suitably from 0.03 to 0.10 g/cm³, and the average cell diameter is suitably in a range of 340 to 520 μm.

In the present invention, in order to secure adhesion between a shaft and an elastic layer, an adhesive layer can be provided therebetween as desired. Such an adhesive layer can be formed by using a two-component polyurethane adhesive, an epoxy adhesive, a polyester adhesive, an acrylic adhesive, an acrylic emulsion adhesive, or a urethane emulsion adhesive.

Manufacture of each roller having an elastic layer composed of polyurethane foam obtained in the above-mentioned manner can be carried out, for example, by the following manner. First, a block-shaped elastic body is cut out from polyurethane foam manufactured in an appropriate shape, a hole is made, and a shaft is inserted thereinto via, as desired, an adhesive layer. Thereafter, by grinding the surface of the block-shaped foam to finish in a cylindrical roller shape, thereby obtaining each roller of the present invention. A method in which polyurethane foam and a shaft are integrally formed, and then, unnecessary portion thereof is ground to be finished in a cylindrical roller shape, a method in which polyurethane foam and a shaft are integrally formed in a mold having a roller shape, a method in which polyurethane foam is made into a cylindrical body by peeling processing, and then a burr which is generated by the peeling processing is melted, or the like can be appropriately used.

The method of manufacturing an image forming device of the present invention is, in manufacturing an image forming device comprising at least two types of rollers selected from the group consisting of a toner feed roller, a transfer roller and a cleaning roller, characterized in that, as the at least two types of rollers, one comprising, on the outer periphery of a shaft, an elastic layer composed of polyurethane foam of the same composition is used. By this, in a method of manufacturing of the present invention, the cost needed for a roller member as a whole can be reduced, as well as the production efficiency can be improved. Regarding other characteristics, a usual method can be appropriately carried out and not particularly limited thereto.

### EXAMPLES

The present invention will now be described in detail by way of Examples. Polyurethane foam (manufactured by Bridgestone Corporation) having a density of 0.10 g/cm³ and an average cell diameter of 340 μm manufactured by free foaming was prepared. Next, a binder (manufactured by Enex Co., Ltd., SE binder, aqueous urethane resin dispersion), silicone powder having a solid content of 50% by mass (manufactured by Dow Corning Toray Co., Ltd.) (2.6 g/L), a conducting agent (manufactured by Lion Corporation, Lion paste W311N) and a self-emulsifying silicone antifoaming agent were mixed to prepare an impregnation liquid. In a bath filled with the above-mentioned impregnation liquid, the above-mentioned polyurethane foam in a block shape (16 mm×1000 mm×2000 mm) was immersed, and compressed between two rolls, then released to impregnate urethane foam with the impregnation liquid. The impregnated urethane foam was guided out of the bath to pass a nip roll to squeeze surplus impregnation liquid. After removing surplus impregnation liquid, the urethane foam was heat dried in a hot air furnace at a temperature of 110° C. for 10 minutes to obtain each electrically conductive urethane foam. The amount of the impregnation liquid attached can be adjusted by the pressure during the compression after the block shaped urethane foam was taken out from the impregnation liquid, or by changing the concentration of carbon, silicone powder and binder in the impregnation liquid.

Each block of electrically conductive polyurethane foam obtained above was cut into a square bar shape of 20×20×230 mm. A shaft hole of φ 5 mm was made in the foam along a longitudinal direction. Next, into the shaft hole, an Ni plated steel shaft of φ 6 mm on which a urethane hot melt adhesive was applied in a thickness of about 50 μm was inserted to be heated and cooled, thereby bonding them together. Next, both sides of the shaft were held and the outer periphery of the shaft was ground, and by cutting end portions of the foam off, a roller 11.5 mm in diameter and 220 mm in length having a high dimension accuracy was obtained.

By subjecting the obtained roller to a heat pressing process at 150° C. for 60 minutes at the compression rate listed on the Table below, a toner feed roller (Table 1), a transfer roller (Table 2), and a cleaning roller (Table 3) were manufactured. For each test roller, an evaluation was performed according to the following description, and the results are listed on the Table below in combination.

### <Compression Rate of Roller>

The compression rate of a roller is a value defined by the following expression where the thickness of an elastic layer of each test roller before inserting into a cylindrical member at the time of a heat pressing process is R (mm), and the thickness of the compressed elastic layer of each test roller after inserting into a cylindrical member is r (mm).

{(R−r)/R}×100 (%)

### <Processability>

Regarding the processability, when the compression rate of each test roller during the heat pressing process was 30% or smaller, the evaluation was indicated as “⊚”; when the compression rate was larger than 30% and 50% or smaller, the evaluation was indicated as “∘”; and when the compression rate was larger than 50%, the evaluation was indicated as “Δ”. This is because when the compression rate was larger than 30%, load at the time of insertion becomes high, which deteriorates workability; and when the compression rate was higher than 50% the foam may break at the time of the insertion.

### <Sweeping Ability>

A metal sleeve on the surface of which toner was uniformly applied was rotated at 32 rpm, and each test roller was pressed against the metal sleeve at a pressing amount of 1 mm for 10 seconds. Thereafter, residual toner on the metal sleeve was collected by attaching the toner to a cellophane tape, and the amount of residual toner was quantified by using a transmission densitometer. The higher the sweeping ability, the smaller the residual toner, and thus the lower transmission density. The toner conveying roller and the cleaning roller are different in the level of sweeping ability; the cleaning roller has a higher required performance. Regarding the toner conveying roller, when the transmission density was lower than 1.05, the sweeping ability was indicated as “⊚”; when the transmission density was 1.05 or higher and lower than 1.10, the sweeping ability was indicated as “∘”; and when the transmission density was 1.10 or higher, the sweeping ability was indicated as “×”. Regarding the cleaning roller, when the transmission density was lower than 1.00, the sweeping ability was indicated as “⊚”; when the transmission density was 1.00 or higher and lower than 1.05, the sweeping ability was indicated as “∘”; and when the transmission density was 1.05 or higher, the sweeping ability was indicated as “×”.

### <Surface Smoothness>

For each test roller, by using a non-contact laser measuring device, the distance from a baseline to a roller profile line was measured. By sequentially measuring the above-mentioned distance while moving along the longitudinal direction of the roller, the shape profile in the longitudinal direction of the roller was measured to calculate the surface roughness parameter Ra. When the surface roughness Ra was less than 5, the surface smoothness was indicated as “⊚”; when the surface roughness Ra was 5 or more and less than 10, the surface smoothness was indicated as “∘”; and when the surface roughness Ra was 10 or more, the surface smoothness was indicated as “×”.

### <Toner Conveying Ability>

Polyurethane foam of an elastic layer of each test roller was filled with toner, and the test roller was rolled being pressed by 1 mm to measure the weight of toner discharged per 220 mm in width and 50 mm in rolling distance. When the weight of toner was 0.12 g or more, the toner conveying ability was indicated as “⊚”; when the weight of toner was 0.10 g or more and less than 0.12 g, the toner conveying ability was indicated as “∘”; and when the weight of toner was less than 0.10 g, the toner conveying ability was indicated as “×”.

TABLE 1

| | | Experimental | Experimental | Experimental | Experimental | Experimental | Experimental |
|---|---|---|---|---|---|---|---|
| | | Example 1 | Example 2 | Example 3 | Example 4 | Example 5 | Example 6 |
| Heat | Presence or | Absent | Present | Present | Present | Present | Present |
| pressing | absence of | | | | | | |
| process | process | | | | | | |
| | Compression | — | 5 | 10 | 20 | 30 | 50 |
| | rate (%) | | | | | | |
| | Processability | — | ⊚ | ⊚ | ⊚ | ⊚ | ◯ |
| Sweeping | Evaluation | ◯ | ⊚ | ⊚ | ⊚ | ⊚ | ⊚ |
| ability | Transmission | 1.07 | 1.04 | 1.03 | 0.97 | 0.97 | 0.95 |
| | density (—) | | | | | | |
| Surface | Evaluation | — | — | — | — | — | — |
| smoothness | Roughness Ra | 42 | 5 | 5 | 4 | 4 | 4 |
| | (μm) | | | | | | |
| Toner | Evaluation | ⊚ | ⊚ | ⊚ | ◯ | X | X |
| conveying | Conveyed | 0.19 | 0.16 | 0.14 | 0.10 | 0.07 | 0.05 |
| ability | amount (g) | | | | | | |

TABLE 2

| | | Experimental | Experimental | Experimental | Experimental | Experimental | Experimental |
|---|---|---|---|---|---|---|---|
| | | Example 7 | Example 8 | Example 9 | Example 10 | Example 11 | Example 12 |
| Heat | Presence or | Absent | Present | Present | Present | Present | Present |
| pressing | absence of | | | | | | |
| process | process | | | | | | |
| | Compression | — | 5 | 10 | 20 | 30 | 50 |
| | rate (%) | | | | | | |
| | Processability | — | ⊚ | ⊚ | ⊚ | ⊚ | ◯ |
| Sweeping | Evaluation | — | — | — | — | — | — |
| ability | Transmission | 1.07 | 1.04 | 1.03 | 0.97 | 0.97 | 0.95 |
| | density (—) | | | | | | |
| Surface | Evaluation | X | ◯ | ⊚ | ⊚ | ⊚ | ⊚ |
| smoothness | Roughness Ra | 42 | 5 | 4 | 4 | 4 | 4 |
| | (μm) | | | | | | |
| Toner | Evaluation | — | — | — | — | — | — |
| conveying | Conveyed | 0.19 | 0.16 | 0.14 | 0.10 | 0.07 | 0.05 |
| ability | amount (g) | | | | | | |

TABLE 3

| | | Experimental | Experimental | Experimental | Experimental | Experimental | Experimental |
|---|---|---|---|---|---|---|---|
| | | Example 13 | Example 14 | Example 15 | Example 16 | Example 17 | Example 18 |
| Heat | Presence or | Absent | Present | Present | Present | Present | Present |
| pressing | absence of | | | | | | |
| process | process | | | | | | |
| | Compression | — | 5 | 10 | 20 | 30 | 50 |
| | rate (%) | | | | | | |
| | Processability | — | ⊚ | ⊚ | ⊚ | ⊚ | ◯ |
| Sweeping | Evaluation | X | ◯ | ◯ | ⊚ | ⊚ | ⊚ |
| ability | Transmission | 1.07 | 1.04 | 1.03 | 0.97 | 0.97 | 0.95 |
| | density (—) | | | | | | |
| Surface | Evaluation | — | — | — | — | — | — |
| smoothness | Roughness Ra | 42 | 5 | 5 | 4 | 4 | 4 |
| | (μm) | | | | | | |
| Toner | Evaluation | — | — | — | — | — | — |
| conveying | Conveyed | 0.19 | 0.16 | 0.14 | 0.10 | 0.07 | 0.05 |
| ability | amount (g) | | | | | | |

As listed on the above-mentioned Table, it was confirmed that, by appropriately changing heat pressing process conditions in a roller having an elastic layer composed of polyurethane foam of the same composition, the required performance corresponding to each of a toner feed roller, a transfer roller, and a cleaning roller was satisfied.

### REFERENCE SIGNS LIST

10 Image forming member
11 Developing roller
12 Toner feed roller
13 Toner storage unit
14 Transfer roller
15 Cleaning roller
16 Layer forming blade
17 Charging roller
20 Toner

1. An image forming device comprising, on the outer periphery of a shaft, at least two types of rollers each having an elastic layer composed of polyurethane foam of the same composition, wherein the at least two types of rollers are selected from the group consisting of a toner feed roller, a transfer roller and a cleaning roller.

2. The image forming device according to claim 1, wherein at least one of the at least two types of rollers is subjected to a heat pressing process.

3. The image forming device according to claim 1, wherein the at least two types of rollers are a toner feed roller and a transfer roller, the compression rate of the toner feed roller in the heat pressing process is lower than 30%, and the compression rate of the transfer roller in the heat pressing process is from 5% to 50%.

4. The image forming device according to claim 3, wherein the at least two types of rollers are a toner feed roller and a transfer roller, the compression rate of the toner feed roller in the heat pressing process is 20% or lower, and the compression rate of the transfer roller in the heat pressing process is from 5% to 50%.

5. The image forming device according to claim 4, wherein the at least two types of rollers are a toner feed roller and a transfer roller, the compression rate of the toner feed roller in the heat pressing process is 20% or lower, and the compression rate of the transfer roller in the heat pressing process is from 10% to 30%.

6. The image forming device according to claim 2, wherein the at least two types of rollers are a toner feed roller and a cleaning roller, the compression rate of the toner feed roller in the heat pressing process is lower than 30%, and the compression rate of the cleaning roller in the heat pressing process is from 5% to 50%.

7. The image forming device according to claim 6, wherein the at least two types of rollers are a toner feed roller and a cleaning roller, the compression rate of the toner feed roller in the heat pressing process is 20% or lower, and the compression rate of the cleaning roller in the heat pressing process is from 5% to 50%.

8. The image forming device according to claim 7, wherein the at least two types of rollers are a toner feed roller and a cleaning roller, the compression rate of the toner feed roller in the heat pressing process is 20% or lower, and the compression rate of the cleaning roller in the heat pressing process is from 20% to 30%.

9. The image forming device according to claim 2, wherein the at least two types of rollers are a transfer roller and a cleaning roller, the compression rate of the transfer roller in the heat pressing process is from 5% to 50%, and the compression rate of the cleaning roller in the heat pressing process is from 5% to 50%.

10. The image forming device according to claim 9, wherein the at least two types of rollers are a transfer roller and a cleaning roller, the compression rate of the transfer roller in the heat pressing process is from 10% to 30%, and the compression rate of the cleaning roller in the heat pressing process is from 5% to 50%.

11. The image forming device according to claim 10, wherein the at least two types of rollers are a transfer roller and a cleaning roller, the compression rate of the transfer roller in the heat pressing process is from 10% to 30%, and the compression rate of the cleaning roller in the heat pressing process is from 20% to 30%.

12. The image forming device according to claim 2, wherein the at least two types of rollers are a toner feed roller, a transfer roller and a cleaning roller, the compression rate of the toner feed roller in the heat pressing process is lower than 30%, the compression rate of the transfer roller in the heat pressing process is from 5% to 50%, and the compression rate of the cleaning roller in the heat pressing process is from 5% to 50%.

13. The image forming device according to claim 12, wherein the at least two types of rollers are a toner feed roller, a transfer roller and a cleaning roller, the compression rate of the toner feed roller in the heat pressing process is 20% or lower, the compression rate of the transfer roller in the heat pressing process is from 10% to 30%, and the compression rate of the cleaning roller in the heat pressing process is from 20% to 30%.

14. A method of manufacturing an image forming device comprising at least two types of rollers selected from the group consisting of a toner feed roller, a transfer roller and a cleaning roller, characterized in that,
as the at least two types of rollers, one comprising, on the outer periphery of a shaft, an elastic layer composed of polyurethane foam of the same composition is used.

15. The method of manufacturing an image forming device according to claim 14, wherein at least one of the at least two types of rollers is subjected to a heat pressing process.
